(19) United States
(12) Patent Application Publication
(10) Pub. No.: US 2005/0086067 A1
(43) Pub. Date: Apr. 21, 2005

(54) Business method for centrally locating a fitness center behind a translucent partition in a multi-unit structure lobby

(76) Inventor: John Sarver, Roswell, GA (US)

Correspondence Address: HILL, KERTSCHER & PIXLEY LLP, 3350 RIVERWOOD PARKWAY, SUITE 800, ATLANTA, GA, 30339, US

(21) Appl. No.: 10/689,926

(22) Filed: Oct. 20, 2003

(51) Int. Cl. G06F 17/60

(52) U.S. Cl. 705/1; 705/8

(57) ABSTRACT

Generally, the current invention is a business method of hotel, resort or other multi-unit dwelling construction and operation centered around a fitness center. The central feature of the invention is a fitness center that is adjacent to, and thus, easily viewed from, both the entrance to the hotel, resort or other multi-unit dwelling lobby and from the reception desk. Said fitness center is behind a glass or otherwise translucent material partition. The fitness center is amenable to any and all regional demands, consumer needs or construction and floor plan restraints.

### CROSS REFERENCE TO RELATED APPLICATION

This is a first patent from the inventor regarding this invention.

### BACKGROUND OF THE INVENTION

### Field of the Invention

The current invention is a business method for the hotel, resort and other multi-unit dwellings industry. This unique business method incorporates a highly visible fitness center into both existing and as yet envisioned hotel, resort or other multi-unit dwelling structures.

The purpose of the present invention is to fulfill a need in the hotel, resort and multi-unit dwelling industry. Current hotel, resort and other multi-unit dwelling fitness centers are underutilized. This business method will benefit both society and hotel developers by overcoming the obstacles of the prior art and increasing utilization of hotel and multi-unit dwelling fitness centers. For hotel, resort or other multi-unit dwelling developers, this business method will provide both financial reward and customer loyalty. Multi-unit dwelling developers will see financial reward not only in an increase of their revenue per unit, because the increased visibility will create a better point of purchase, but also in ancillary income, which may be found in charging admission to the fitness center and/or the optional and additional revenue producing business such as the smoothie bar or the fitness apparel and equipment retail centers. Society will benefit because hotel and multi-unit dwelling consumers will experience increased safety and unique social facilitation, in a design that is not currently available. Additionally, hotel, resort and multi-unit dwelling consumers will now have available a healthier means of travel or living.

### SUMMARY OF THE INVENTION

The present invention overcomes the inadequacies of current hotel, office building and multi-unit dwelling design. Generally, the present invention is a business method for hotel, resort or other multi-unit dwelling operation which centers hotel, resort or other multi-unit dwelling design, construction and operation around a fitness center. The advantage of such a hotel, resort or other multi-unit dwelling construction and operation is that utilizing this business method will appeal to a particular subset of hotel, resort or other multi-unit dwelling patrons, thus increasing revenue per unit, guest retention and consumer satisfaction.

As demonstrated herein, the central feature of this business method is a fitness center that is adjacent to, and thus, easily viewed from both the entrance to the hotel, resort or multi-unit dwelling lobby and from the reception desk, said fitness center is behind a glass or otherwise translucent material partition. As described herein, this method of hotel and multi-unit dwelling construction and operation can be achieved in several different formats, each representing a preferred embodiment of the invention. This will make the business method useful to both existing and yet-to-be constructed hotel, resort or other multi-unit dwelling facility. The equipment and layout of the interior of the fitness center itself remains modifiable according to hotel brand, regional demand and consumer needs.

The predominant feature of this invention is the position of the fitness center, in all its various embodiments, in regards to the lobby and/or entrance to the establishment; and the glass or otherwise translucent material partition between said fitness center and said lobby. The benefit of this feature is that it is amenable to both existing and as-yet constructed hotels or multi-unit dwellings. It is compatible with any hotel design, including without limitation, Doubletree Club, Embassy Suites, Hampton Inn, Hilton Garden Inn and any other variation of hotel or resort chain's respective floor plans. Further, this feature is equally amenable to custom design for a new hotel or for an existing hotel with special regional, construction or consumer needs.

As will be immediately apparent to one of skill in the art, the predominant feature may also be incorporated in the design and construction of any multi-unit structure, such as resorts, office buildings and multi-unit long or short term residential structures.

### BRIEF DESCRIPTION OF THE DRAWINGS

The present invention, as defined in the claims, can be better understood with reference to the following drawings. The drawings are not necessarily to scale, and the invention is not intended to be limited by the measurements or preferred features of these drawings.

FIG. 1 is a perspective view of one embodiment of a hotel or multi-unit dwelling lobby utilizing the business method.

FIG. 2 is a perspective view of a hotel or multi-unit dwelling lobby utilizing the business method.

FIG. 3 is an aerial depiction of an embodiment of a hotel or multi-unit dwelling lobby plus fitness center implementing the business method with reference to the optional health food refreshment retail opportunity and optional location for locker rooms and fitness center office.

FIG. 4 is an aerial depiction of an embodiment of a hotel or multi-unit dwelling lobby plus fitness center implementing the business method without reference to any retail opportunities.

FIG. 5 is an aerial depiction of one way in which a hotel or multi-unit dwelling may implement this business method while considering floor plan and construction restrictions.

FIG. 6 is second aerial depiction of one way in which a hotel or multi-unit dwelling may implement this business method while considering floor plan and construction restrictions.

### DETAILED DESCRIPTION OF THE PREFERRED EMBODIMENT

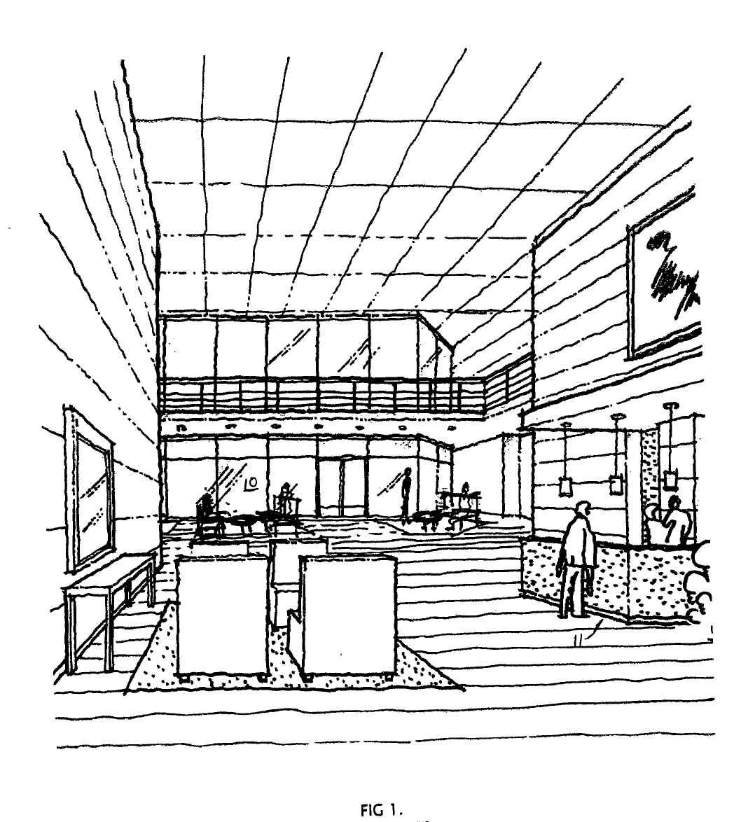

FIG. 1 depicts one example of a hotel or multi-unit dwelling lobby layout optimizing the location of the fitness center, utilizing the business method. The vantage point of the rendering is as one would enter the hotel or multi-unit dwelling lobby. Glass or otherwise translucent material partition 10 is adjacent to, and therefore, easily viewed from both the entrance and reception desk 11. The multi-unit dwelling may be, for example, but is not limited to, a resort, a vacation time share property, a multi-unit temporary residential structure, a multi-unit long-term residential structure, a multi-unit retirement facility, a multi-unit dwelling structure associated with a large leisure destination or any other multi-unit structure where people reside, long or short-term, or work. Partition 10 is made of glass or an otherwise translucent material in the preferred embodiment; however, it will be obvious to those skilled in the art that it could be made of any material providing a suitable aesthetic division and sound barrier, including without limitation, plant material, fabric, screens or art.

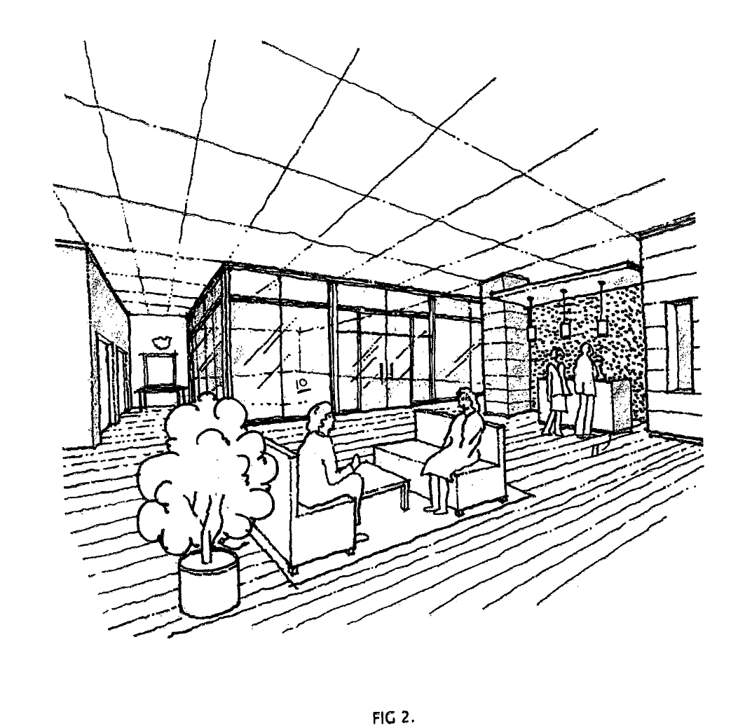

FIG. 2 depicts another example of a hotel, resort or other multi-unit dwelling lobby layout optimizing the location of the fitness center, utilizing the business method. The vantage point of the rendering is as one would enter the hotel or multi-unit dwelling lobby. Glass or otherwise translucent material partition 10 is easily viewed from both the entrance and reception desk 11.

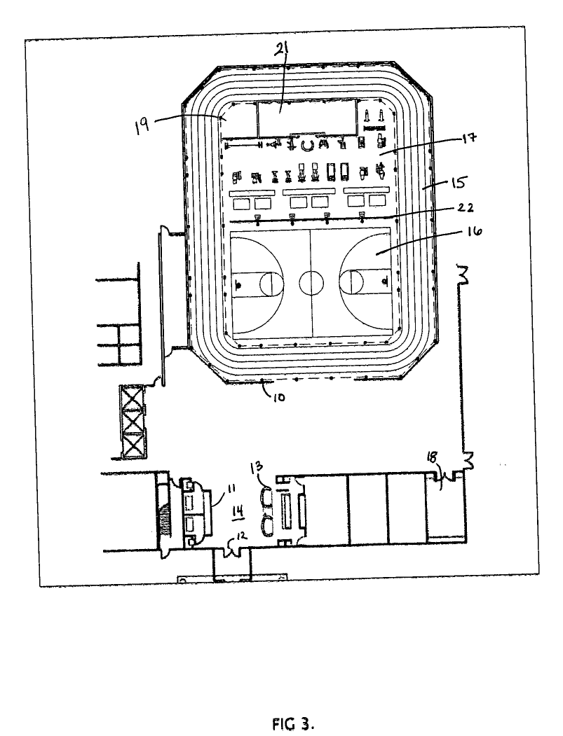

FIG. 3 depicts an aerial view of a non-exclusive preferred embodiment of the business method. The front entrance 12 leads into lobby 14 in which is located the reception desk 11. Also in lobby 14, there is the refreshment retail area 13. The refreshment retail area 13 may comprise simply a food and beverage bar adjacent to the hotel or multi-unit dwelling lobby and the glass or otherwise translucent material partition 10. The refreshment retail area 13 may also comprise a smoothie bar adjacent to the hotel or multi-unit dwelling lobby 14 and the glass or otherwise translucent material partition 10. Also in this depiction are the locker rooms and the fitness center office 18.

Each of these elements is optional and may exist elsewhere in the hotel, resort or other multi-unit dwelling construction. The immediate view of the patron is glass or otherwise translucent material partition 10. The view through the glass or otherwise translucent material partition 10 looks onto an optional running track 15. This optional running track 15 may be indoors or outside, as the needs of construction or design require. Within the optional running track 15 is an optional basketball court 16, the space for which may be used as either a basketball court 16, group exercise area or any other activity of the hotel or multi-unit dwelling's fitness needs require. This optional basketball court 16 may be located indoors or outside, as the needs of construction or design require. Basketball court 16 may or may not be located within running track 15. Next to the optional basketball court is a second optional glass or otherwise translucent partition 22, beyond which is a cardiovascular and strength equipment room 17 possessing cardiovascular and strength training equipment, including, but not limited to, treadmills, recumbent cycles, elliptical trainers, free weights and/or mechanized weight lifting equipment. Beyond the cardiovascular and strength equipment room 17 lies optional group exercise 21 and personal fitness massage areas 19.

Elements 21 and 19 are also optional and may exist in a different location so within the fitness center as a hotel, resort or other multi-unit dwelling needs require. The personal fitness massage area 19 is only one example of a “spa facility” that is optional in the inventor's preferred embodiment. Other examples of a “spa facility” include a sauna, a whirlpool, a steam room, and a shower.

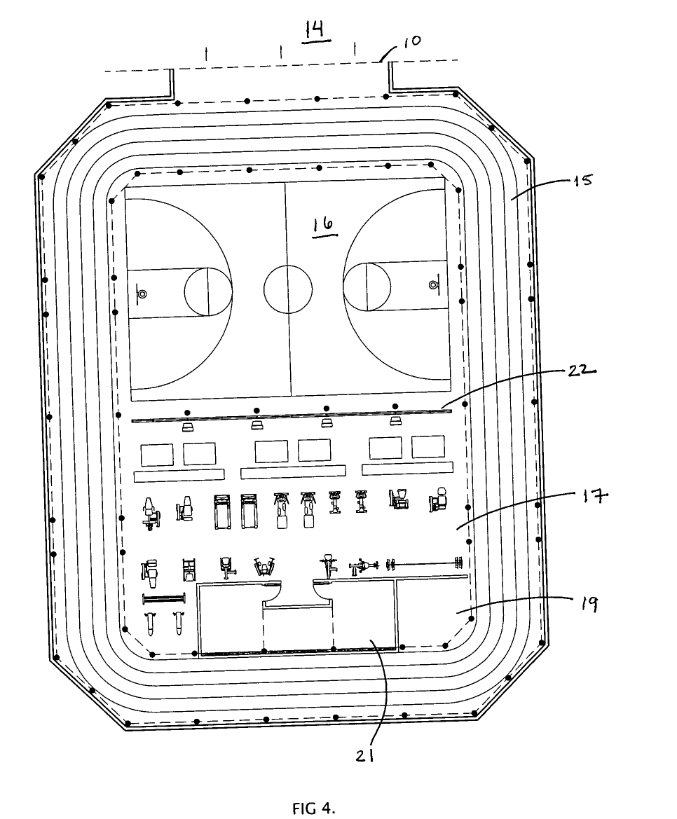

FIG. 4 depicts an aerial view of the fitness center without reference to a health refreshment retail opportunity or the location of the fitness center office and/or restrooms. The core element, glass or otherwise translucent partition 10 facing lobby atrium 14 and exercise opportunities are represented in this figure. The optional running track 15, optional basketball court 16, optional second glass or otherwise translucent material partition 22, cardiovascular and strength equipment room 17, group exercise 21 and personal fitness and massage 19 are still represented in this figure. Each element is interchangeable, excludable and optional, as long as at least one element remains behind the glass or otherwise translucent material 10 partition facing the lobby atrium.

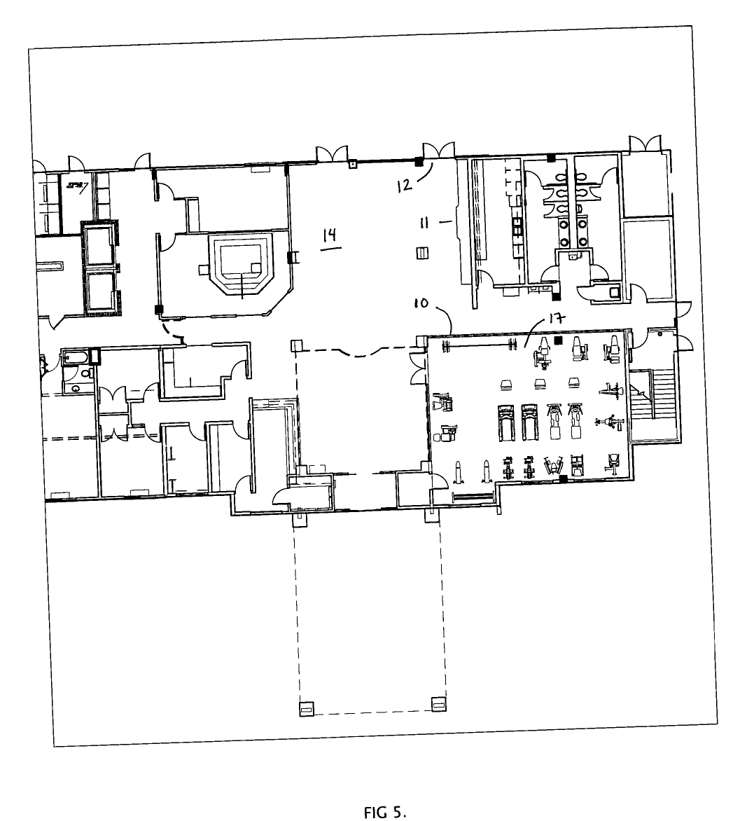

FIG. 5 is an aerial view of the fitness center, as it might exist as a singular element, here, the cardiovascular and strength equipment room 17 behind the glass or otherwise translucent partition 10 facing lobby atrium 14. The front entrance 12 leads into lobby 14 in which is located the reception desk 11. This figure is one representation of how a or hotel, resort or other multi-unit dwelling may achieve the fitness center business method described herein while accommodating construction or space requirements. Though not depicted here, a hotel, resort or other multi-unit dwelling may easily replace the cardiovascular and strength equipment room 17 with running track 15 or basketball court 16 or group exercise area 21 or any other fitness opportunity. A hotel, resort or other multi-unit dwelling may also easily add a refreshment retail area 13. The refreshment retail area 13 may comprise simply a food and beverage bar adjacent to the hotel, resort or other multi-unit dwelling lobby 14 and the glass or otherwise translucent material partition 10. The refreshment retail area 13 may also comprise a smoothie bar adjacent to the hotel, resort or other multi-unit dwelling lobby 14 and the glass or otherwise translucent material partition 10.

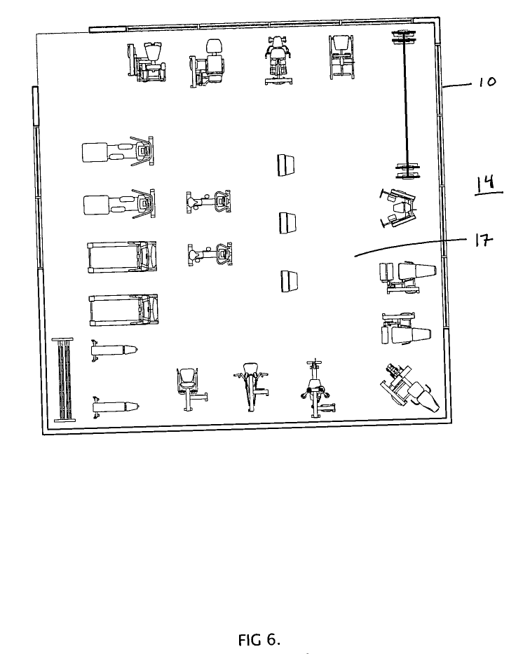

FIG. 6 is an example of a singular element, the cardiovascular and strength equipment room 17 behind the glass or otherwise translucent partition 10 facing lobby and atrium 14. This figure is one representation of how a hotel or multi-unit dwelling may achieve the fitness center business method described herein while accommodating construction or space requirements. Though not depicted here, a hotel, resort or other multi-unit dwelling may easily replace the cardiovascular and strength equipment room 17 with running track 15 or basketball court 16 or group exercise area 21 or any other fitness opportunity.

As will be apparent to one of ordinary skill in the art, the invention is by no means limited to the particular embodiments that have been discussed above, or even to variations that have been discussed in connection with them. Variations or modifications could be made in accordance with the construction and/or operation of hotel or multi-unit dwelling fitness centers without departing from the spirit and scope of the invention, and it is contemplated that this invention covers such variations, modifications and any equivalents of the invention. In short, the present invention is limited in scope only by the claims that now follow.

1. A business method of hotel construction, operation or renovation for centering a hotel around a fitness center so that said fitness center is visible from a hotel lobby, comprising the steps of:
Providing a location for said fitness center that is adjacent to and visible from said hotel lobby; and
Using a glass or otherwise translucent material partition to separate said fitness center from said hotel lobby.

2. The business method of claim one wherein said fitness center includes a cardiovascular and strength equipment room.

3. The business method of claim one wherein said fitness center includes a running track.

4. The business method of claim one wherein the fitness center includes a basketball court.

5. The business method of claim one wherein said fitness center includes at least one group exercise room.

6. The business method of claim one wherein said fitness center includes at least one independent exercise room.

7. The business method of claim one wherein said fitness center contains a spa facility.

8. The business method of claim one wherein said fitness center contains men and women's locker rooms.

9. The business method of claim eight wherein said locker rooms contain men and women's restroom facilities.

10. The business method of claim one wherein said fitness center includes a cardiovascular and strength equipment room, a running track, a basketball court and men and women's locker rooms.

11. The business method of claim one wherein said fitness center includes a cardiovascular and strength equipment room, a running track, at least one group exercise room and men and women's locker rooms.

12. The business method of claim one wherein said fitness center includes a cardiovascular and strength equipment room, a running track, at least one independent exercise room and men and women's locker rooms.

13. The business method of claim one wherein said fitness center includes a cardiovascular and strength equipment room, a running track, a spa facility, and men and women's locker rooms.

14. The business method of claim one wherein said fitness center includes a running track, a basketball court, at least one group exercise room, at least one independent exercise room, a spa facility and men and women's locker rooms.

15. The business method of claim one wherein said partition is made of Plexiglas.

16. The business method of claim one wherein the said partition is made of clear glass.

17. The business method of claim one wherein said partition is made of a plastic material.

18. The business method of claim one wherein said partition is made of smoked glass.

19. The business method of claim one wherein both opaque and non-opaque panels comprise said partition in whole or in part.

20. The business method of claim one, further comprising the step of providing a food and beverage bar adjacent to said hotel lobby and said fitness center.

21. The business method of claim fourteen further comprising the step of providing a smoothie bar adjacent to said hotel lobby and said fitness center.

22. The business method of claim one, further comprising the step of providing a retail area offering fitness apparel for sale.

23. The business method of claim one, further comprising the step of providing a retail area offering personal exercise equipment for sale.

24. The business method of claim fourteen, further comprising the steps of:
providing a food and beverage bar adjacent to said hotel lobby and said fitness center; and
providing a retail area offering at least one of the following items for sale:
personal exercise equipment for sale; and/or
fitness apparel.

25. A business method of multi-unit dwelling construction, operation or renovation for centering a multi-unit dwelling around a fitness center so that said fitness center is visible from a multi-unit dwelling lobby, comprising the steps of:
Providing a location for said fitness center that is adjacent to and visible from said multi-unit dwelling lobby; and
Using a glass or otherwise translucent material partition to separate said fitness center from said multi-unit dwelling lobby.

26. The business method of claim twenty-five wherein said fitness center includes a cardiovascular and strength equipment room.

27. The business method of claim twenty-five wherein said fitness center includes a running track.

28. The business method of claim twenty-five wherein the fitness center includes a basketball court.

29. The business method of claim twenty-five wherein said fitness center includes at least one group exercise room.

30. The business method of claim twenty-five wherein said fitness center includes at least one independent exercise room.

31. The business method of claim twenty-five wherein said fitness center contains a spa facility.

32. The business method of claim twenty-five wherein said fitness center contains men and women's locker rooms.

33. The business method of claim thirty-two wherein said locker rooms contain men and women's restroom facilities.

34. The business method of claim twenty-five wherein said fitness center includes a cardiovascular and strength equipment room, a running track, a basketball court and men and women's locker rooms.

35. The business method of claim twenty-five wherein said fitness center includes a cardiovascular and strength equipment room, a running track, at least one group exercise room and men and women's locker rooms.

36. The business method of claim twenty-five wherein said fitness center includes a cardiovascular and strength equipment room, a running track, at least one independent exercise room and men and women's locker rooms.

37. The business method of claim twenty-five wherein said fitness center includes a cardiovascular and strength equipment room, a running track, a spa facility, and men and women's locker rooms.

38. The business method of claim twenty-five wherein said fitness center includes a running track, a basketball court, at least one group exercise room, at least one independent exercise room, a spa facility and men and women's locker rooms.

39. The business method of claim twenty-five wherein said partition is made of Plexiglas.

40. The business method of claim twenty-five wherein the said partition is made of clear glass.

41. The business method of claim twenty-five wherein said partition is made of a plastic material.

42. The business method of claim twenty-five wherein said partition is made of smoked glass.

43. The business method of claim twenty-five wherein both opaque and non-opaque panels comprise said partition in whole or in part.

44. The business method of claim twenty-five, further comprising the step of providing a food and beverage bar adjacent to said multi-unit dwelling lobby and said fitness center.

45. The business method of claim thirty-six further comprising the step of providing a smoothie bar adjacent to said multi-unit dwelling lobby and said fitness center.

46. The business method of claim twenty-five, further comprising the step of providing a retail area offering fitness apparel for sale.

47. The business method of claim twenty-five, further comprising the step of providing a retail area offering personal exercise equipment for sale.

48. The business method of claim thirty-eight, further comprising the steps of:
providing a food and beverage bar adjacent to said multi-unit dwelling lobby and said fitness center; and
providing a retail area offering at least one of the following items for sale:
personal exercise equipment for sale; and/or
fitness apparel.

49. The business method of claim three, wherein said running track is outdoors.

50. The business method of claim three, wherein said running track is indoors.

51. The business method of claim four, wherein said basketball court is outdoors.

52. The business method of claim four, wherein said basketball court is indoor.

53. The business method of claim one, wherein said partition is made of any material that is translucent in whole or in part, and that provides a sound barrier.

54. The business method of claim twenty-five, wherein said partition is made of any material that is translucent in whole or in part, and that provides a sound barrier.
